(19) United States
(12) Patent Application Publication
(10) Pub. No.: US 2003/0140511 A1
(43) Pub. Date: Jul. 31, 2003

(54) Vial insert for a spirit level

(76) Inventor: Donald L. Obergoenner, Cape Girardeau, MO (US)

Correspondence Address: Ari M. Bai, Greensfelder, Hemker & Gale, P.C., Suite 2000, 10 South Broadway, St. Louis, MO, 63102, US

(21) Appl. No.: 10/354,271

(22) Filed: Jan. 30, 2003

Related U.S. Application Data
(60) Provisional application No. 60/353,554, filed on Jan. 31, 2002.

(51) Int. Cl. G01C 9/24

(52) U.S. Cl. 33/379

(57) ABSTRACT

A detachable vial insert for a spirit level is disclosed comprising a casing defining a cavity for receiving a pair of semi-transparent liquid-filled vials having a longitudinal curvature containing a bubble for providing an indication of a true level plane when the bubble is positioned between two markings placed on the body of the vial. The vial insert may be used as a pre-calibrated stand-alone device or as a replaceable insert for a spirit level.

### BACKGROUND OF THE INVENTION

The present nonprovisional application claims the benefit of U.S. Provisional Application No. 60/353,554 filed Jan. 31, 2002.

1. Field of the Invention

The present invention relates to spirit levels, and more particularly to a spirit level having detachable vial inserts. More specifically, the present invention relates to a pre-calibrated vial insert for a spirit level.

2. Prior Art

Spirit levels typically include a frame with parallel working surfaces having one or more apertures into which is installed are vials that provide an indicating means to determine if a surface is level. Each leveling vial has a transparent liquid-filled housing with a longitudinal curvature and opposed end portions that are bonded to each end of the apertures level body. A bubble is entrapped in the liquid in each vial for indicating true level when the bubble is located between a pair of indicating marks inscribed on each leveling vial. The indicating marks are positioned such that when the marks on a particular level vial are facing upwardly relative to a resting surface, the bubble will float to the upper inside surface of the leveling vial and be positioned between the marks, thereby indicating true level.

Spirit levels have been constructed using various different arrangements for mounting the leveling vials directly in the frame of the spirit level. However, prior art spirit levels with detachable vials have several drawbacks. The vials previous devices require that the leveling vials be calibrated after being inserted into the apertures of the spirit level, thereby requiring that the spirit level be calibrated by some type of calibration mechanism after assembly. Further, none of the vials of the prior art are capable of being used as a stand-alone level device separate from the spirit level since each vial insert must be calibrated in conjunction with the spirit level.

Therefore, there appears a need in the art for a spirit level having one or more detachable pre-calibrated vial inserts that may also be used as a stand-alone device for indicating true level. There is also a need in the art for a spirit level which contains vial inserts that are easily replaceable, thus making the spirit level easy to repair should it become damaged.

### OBJECTS AND SUMMARY OF THE INVENTION

Accordingly, the primary object of the present invention is to provide a vial insert that may be used as a stand-alone level device.

Another object is to provide a vial insert that is pre-calibrated prior to assembly with a spirit level.

A further object of thee present invention is to provide a spirit level requiring no calibration of the spirit level device itself after assembly is complete.

Yet another object of the present invention is to provide a vial insert that is a single, complete level device.

Another further object of the present invention is to provide a vial insert that is easily removable and repairable.

Yet another further object of the present invention is to provide a method of constructing a vial insert so that it is completely calibrated prior to assembly with the spirit level.

These and other objects of the present invention are realized in the preferred embodiment of the present invention, described by way of example and not by way of limitation, which provides for a spirit level having one or more vial inserts that are pre-calibrated and may read a level surface without attachment to the spirit level.

In brief summary, the present invention overcomes and substantially alleviates the deficiencies in the prior art by providing a spirit level for attachment of one or more pre-calibrated vial inserts. The spirit level of the present invention comprises a frame having one or more apertures for receiving a respective vial insert that has been pre-calibrated and precision formed such that each insert can stand-alone and provide true level to the user without attachment to the frame.

Each vial insert includes a housing defining a chamber that preferably encases a pair of level vials therein. Each level vial includes a casing which contains a predetermined amount of liquid with a bubble formed therein for indicating a true level plane. During calibration of the vial insert, a pair of marking lines are provided on the central portion of each casing for indicating true plane when the bubble is positioned between the two markings. The housing forms a pair of opposed holes that are adapted to receive the respective end portions of each level vial during assembly. Once the vial insert is properly positioned within the holes, the insert itself is calibrated by placing it on a surface having a true level plane and then adjusting the level vials relative to the housing so that the proper marking lines are made along the casing to indicate true level prior to permanently bonding the level vials to the housing. After the vial inserts are properly calibrated, each insert is placed in a respective aperture formed through the level spirit and a pair of lenses are secured to both sides of the housing so that the vial inserts are completely encased with the frame of the spirit level. The housing of each vial insert is precision machined so that a pre-calibrated vial insert can function as a stand-alone spirit level without being engaged to the level frame after assembly.

Additional objects, advantages and novel features of the invention will be set forth in the description which follows, and will become apparent to those skilled in the art upon examination of the following more detailed description and drawings in which like elements of the invention are similarly numbered throughout.

### BRIEF DESCRIPTION OF THE DRAWINGS

FIG. 1 is a perspective view of the spirit level according to the present invention;

FIG. 2 is an exploded view of the spirit level according to the present invention;

FIG. 3a is a cross-sectional view taken along line 3a-3a of FIG. 1 according to the present invention;

FIG. 3b is a cross-sectional view taken along line 3b-3b of FIG. 1 according to the present invention;

FIG. 4 is a perspective view of one embodiment of the vial insert according to the present invention;

FIG. 5 is an end view of the embodiment of the vial level shown in FIG. 4 according to the present invention;

FIG. 6 is a perspective view of another embodiment of the vial insert according to the present invention;

FIG. 7 is an end view of an embodiment of the vial insert shown in FIG. 6 according to the present invention;

FIG. 8 is a front view of one embodiment of a lens according to the present invention;

FIG. 9 is a front view of another embodiment of a lens according to the present invention;

FIG. 10 is an enlarged view of FIG. 2 according to the present invention; and

FIG. 11 is another enlarged view of FIG. 2 according to the present invention.

### DETAILED DESCRIPTION OF THE INVENTION

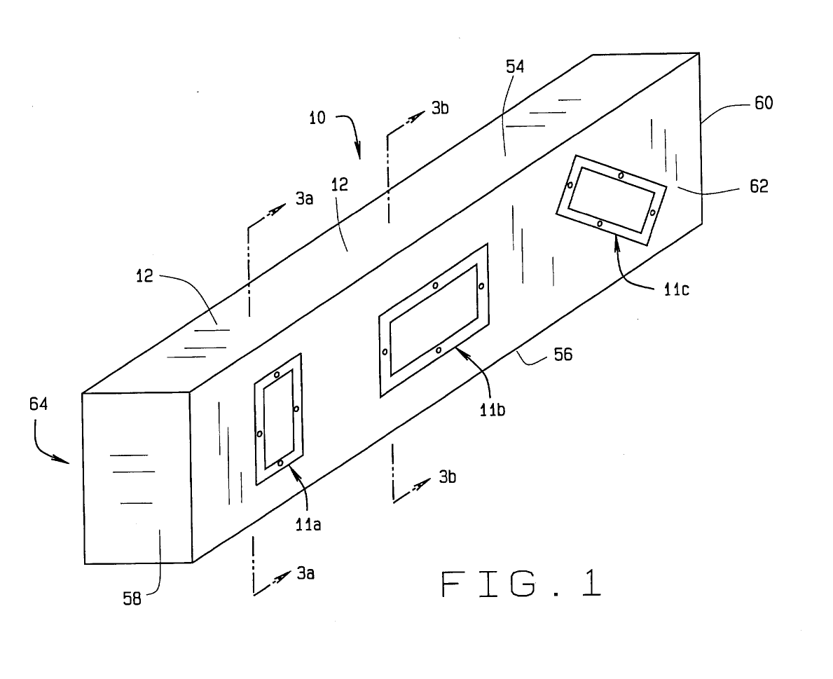

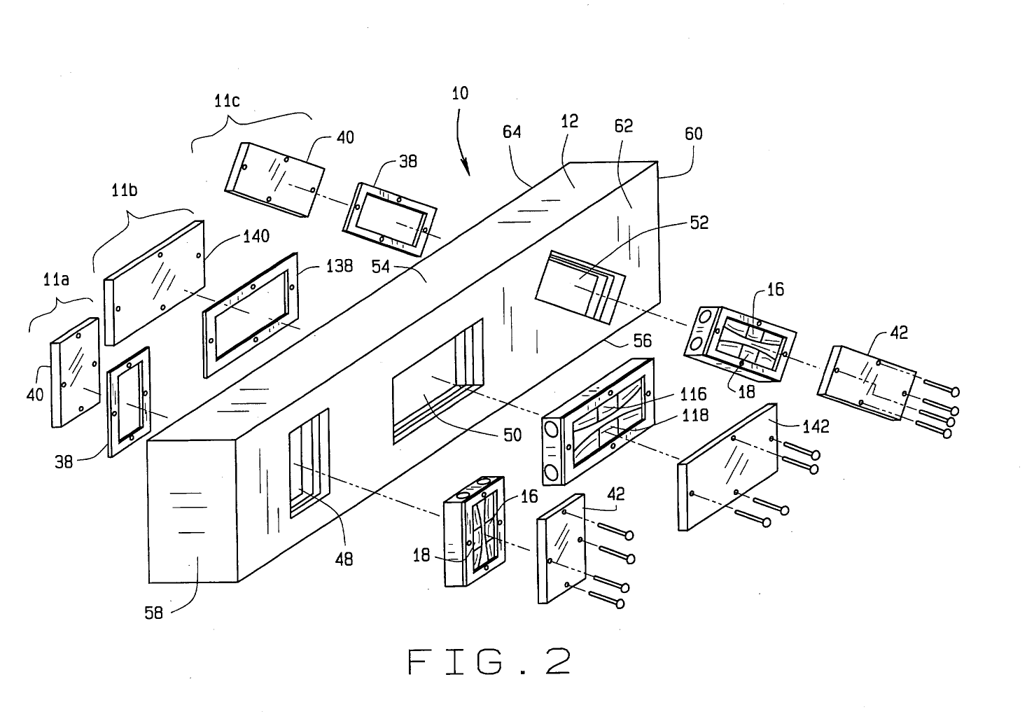

Referring to the drawings, the preferred embodiment of the spirit level of the present invention is illustrated and generally indicated as 10 in FIG. 1. Spirit level 10 comprises a body 12 defined by top and bottom sides 54 and 56, opposing sides 58 and 60, and front and back sides 62 and 64 such that body 12 provides a true level surface. As shown in FIG. 2, body 12 further defines first, second and third apertures 48, 50 and 52 that are adapted to securely receive respective vial inserts 11(a), (b) and (c) according to the present invention.

Vial inserts 11(a), (b), and (c) may be oriented at differing angles with respect to one another in one embodiment of the invention as depicted in FIGS. 1 and 2. In this embodiment, vial insert 11(a) is oriented at a 90 degree angle with respect to vial insert 11(b), while vial insert 11(c) is at a 45 degree angle with respect to the vial insert 11(b). As depicted in FIGS. 1 and 2, aperture 48 is at a 90 degree angle with respect to aperture 50, thereby allowing vial insert 11(a) in aperture 48 to determine plumness of an object, while vial insert 11(b) can be utilized to determine whether or not an object was level. Aperture 52 is oriented at a 45 degree angle with respect to aperture 50, thus allowing the vial insert 11(c) to determine the level of an object set at a 45 degree angle. Alternatively, vial insert 11(c) could be oriented with either vial insert 11(a) or 11(b) but the vials 216 and 218 would have to be set at a 45 degree angle with respect to vial insert 11(b).

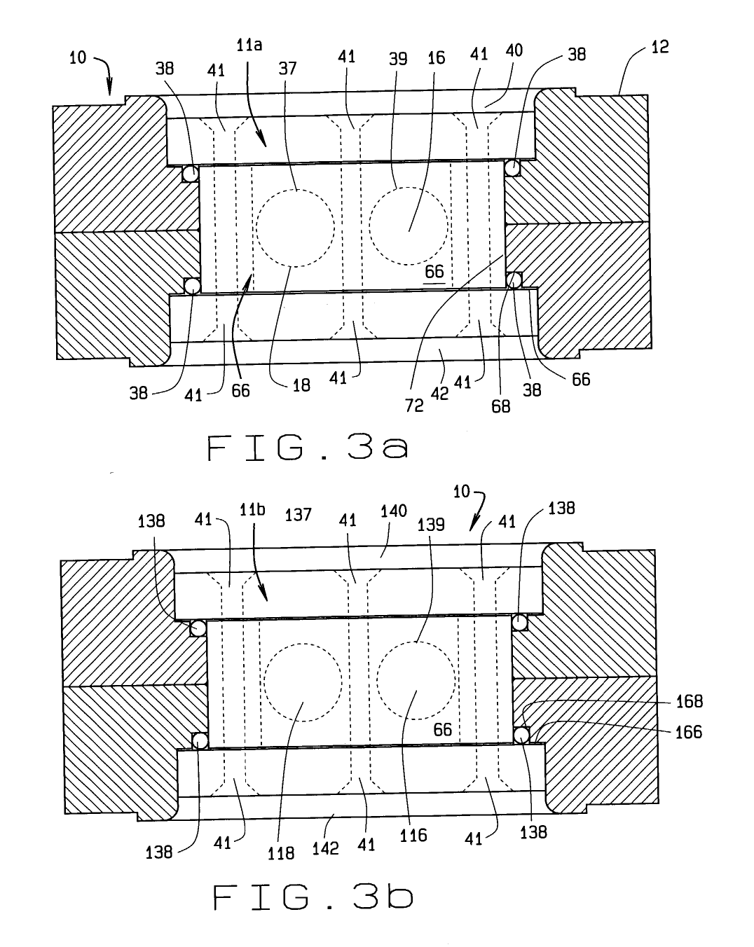

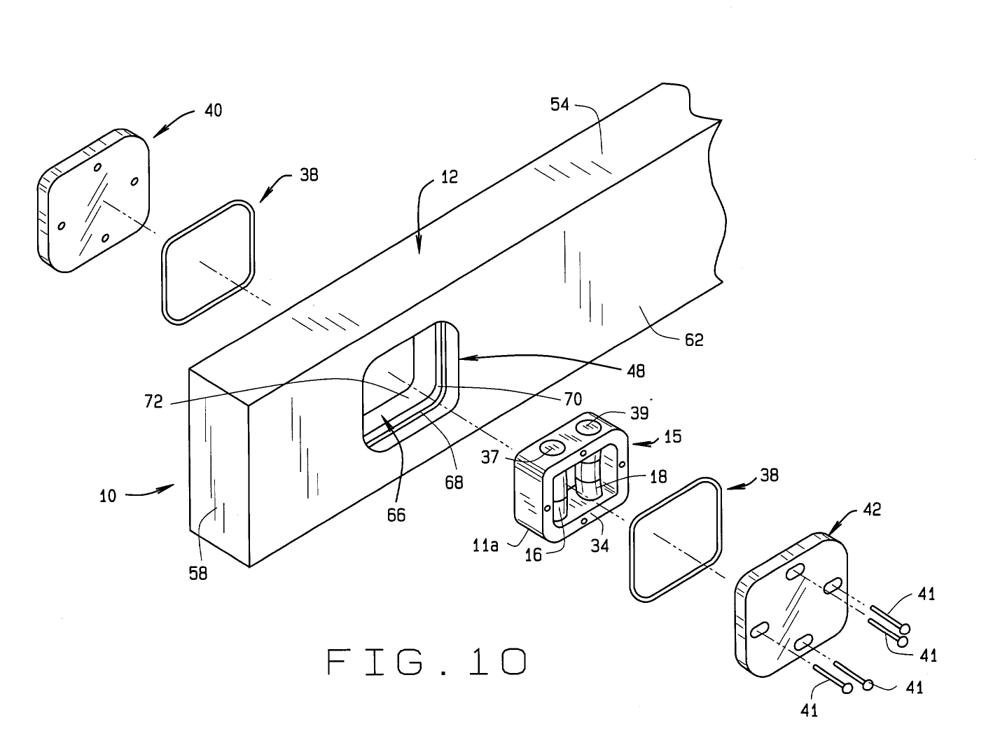

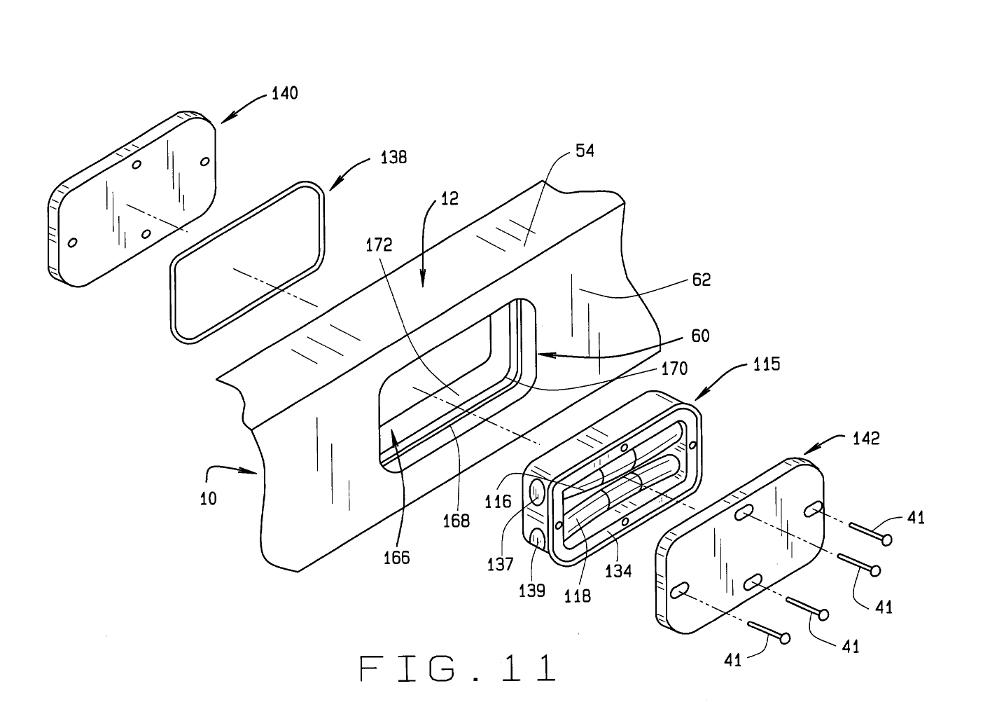

Referring to FIGS. 3(a) and 10, aperture 48 and 52 are adapted to receive vial insert 11(a) or 11(c) and comprise a cavity 66 defining a pair of first shoulders 68 formed adjacent a pair of raised second shoulders 70 with a raised portion 172 interposed between shoulders 70. As illustrated in the FIG. 1, aperture 52 has the exact same configuration as aperture 48 with respect to the means that secure the vial insert to body 12. However, the angular orientations of vial inserts 11(a), (b), and (c) may differ as described above in one embodiment of the invention. As shown in FIGS. 3(b) and 11, aperture 52 is sized and shaped to receive the larger vial insert 11(b) and comprises a cavity 166 defining a pair of first shoulders 168 formed adjacent a pair of raised second shoulders 170 with a raised portion 72 interposed therebetween.

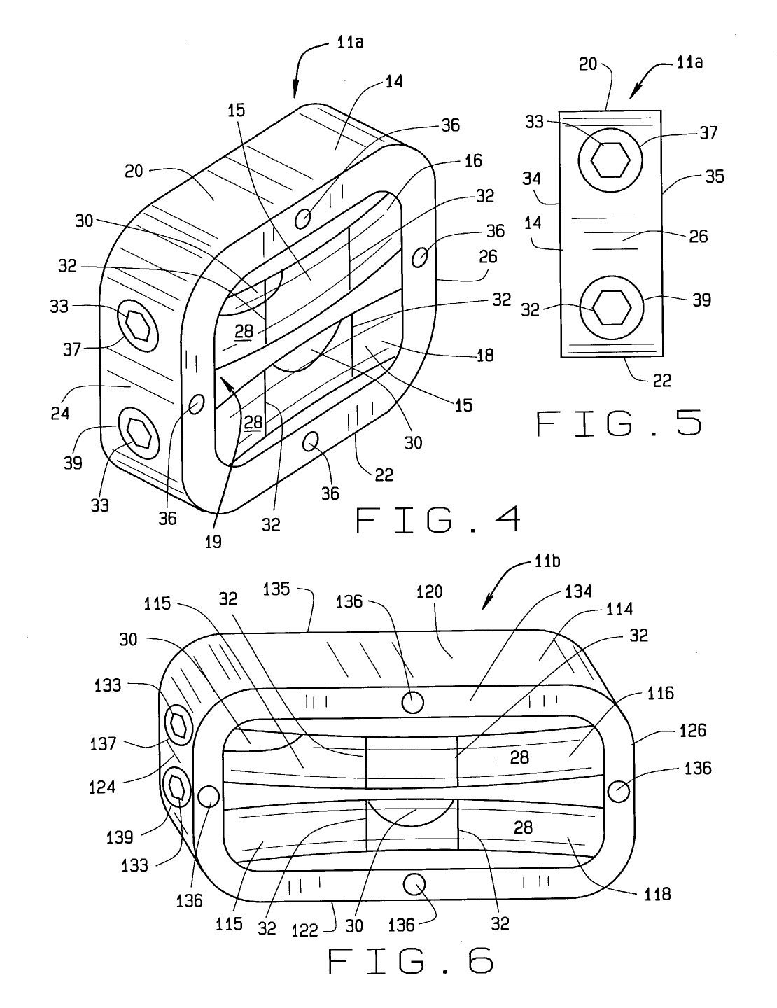

Referring to FIG. 4, vial inserts 11(a) and (c) have generally rectangular configurations with chamfered or beveled edges comprising a housing 14 defined by a top and bottom portions 20 and 22, opposing side portions 24 and 26, and front and back portions 34 and 35. As shown in FIG. 4, both front and back portions 34 and 35 form a plurality of holes 36 along each side of housing 14 (FIG. 5) adapted to receive screws 41 (FIG. 3A) for securing respective first and second lens 40 and 42 to housing 14 during assembly. Opposing side portions 24 and 26 form opposing first and second openings 37 and 39 which are sized and shaped to receive respective end portions 33 of first and second vials 16 and 18. Preferably, first and second vials 16 and 18 each have a casing 15 filled with a fluid 28 containing a bubble 30 for indicating a level plane. The casing 15 has a longitudinal curvature formed between end portions 33 that are bonded to respective openings 37 and 39 formed on opposing sides 24 and 26 as shall be explained in greater detail below. A pair of markings 32 are provided along a central portion of first and second vials 16 and 18 such that bubble 32 lies between markings 32 of one of the vials 16 or 18 when housing 14 is placed on a true level plane.

Referring to FIG. 8, lens 40 is identical to lens 42 which collectively seal casing 15 when vial inserts 11(a) and 11(b) are securely engaged with spirit level 10 during assembly. Lens 40 includes a durable, transparent body having a generally rectangular shape substantially similar to the configuration of casing 15 having holes 46 formed therethrough along all four sides of lens 40. Holes 46 correspond directly to holes 36 formed through housing 14 such that screws 41, or other suitable means of attachment, may secure lens 40 and 42 to opposite sides of casing 15 when installing vial inserts 11(a), (b), and/or (c) to spirit level 10.

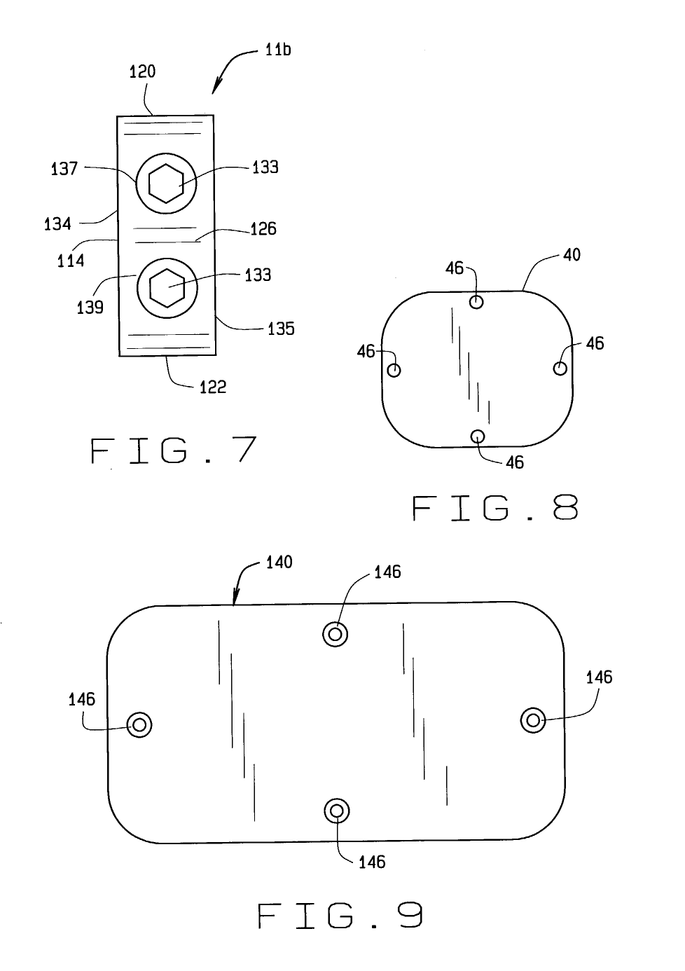

Referring to FIGS. 6 and 7, vial insert 11(b) is substantially similar to vial insert 11(a) except insert 11(b) has a longer rectangular configuration. Vial insert 11(c) is identical to vial insert 11(a) and only differs with respect to either its angular orientation to vial insert 11(b)or the vials 216 and 218's angular orientation relative to vial insert 11(b). As shown, vial insert 11(b) comprises a housing 114 defined by a top and bottom portions 120 and 122, opposing side portions 124 and 126, and front and back portions 134 and 135. Both front and back portions 134 and 135 form a plurality of holes 136 along each side of housing 114 adapted to receive screws 41 for securing respective first and second lens 140 and 142 to housing 114 during assembly. Vial insert 11(b) also forms first and second openings 137 and 139 which are sized and shaped to receive respective end portions 133 of first and second vials 116 and 118.

Similar to vial insert 11(a) and (c), first and second vials 116 and 118 each have a casing 115 filled with a fluid 28 containing a bubble 30 for indicating a level plane. Casing 115 has a longer longitudinal curvature than casing 15 such that the lengths of first and second vials 116 and 118 are substantially similar to the length between opposing side portions 124 and 126. A pair of markings 32 are also provided along the central portion of casing 115 such that bubble 30 is positioned between the markings 32 when vial insert 11(b) is placed on a true level plane.

Referring to FIG. 9, lens 140 and 142 are substantially similar to lens 40 and 42 with the exception that lens 140 and 142 are configured larger to properly fit with casing 115. Lens 140 and 142 also include holes 146 which correspond directly with holes 136 of casing 115 when lens 140 and 142 are engaged to casing 115 using screws 41, or other suitable means of attachment.

To assemble and pre-calibrate vial inserts 11 (a), (b), and or (c), (each vial insert is assembled in a identical manner; however, for simplicity sake, only insert 11(a) will be discussed below but this same process could be utilized for any of the vial inserts 11 (a), (b), and or (c)) the user performs the task with the aid of a true level surface known in the art, which is preferably constructed of granite (not shown) housed in a steel table with adjustable legs (not shown). Before the user may begin the assembly process for the vial insert 11 (a) the granite working surface must be shown to be true level. A completed and calibrated leveling device is used to determine whether or not the granite working surface is at true level. Should the granite working surface not be level, the adjustable legs of the table should be adjusted by known methods in the art, such as by utilizing an Allen® wrench, to raise or lower the legs of the metal table to achieve a level surface on which to construct vial insert 11(a).

After the granite working surface is level, the vial insert housing 14 is placed on the granite working surface so that top and bottom portions 20 and 22 are parallel with the granite working surface. During this stage of the assembly, opposing side portions 24 and 26 should be perpendicular with the granite working surface.

To assemble vial insert 11(a), vial 18 is fully inserted through either opening 37 or 39 until it is fully disposed inside chamber 19 and anchored between openings 37 or 39. To properly position the vial 18 within housing 14, lines 32 should each be of equal distance from side members 26 and 28 respectively. If vial 18 not seated properly in openings 37 or 39, a shim can be utilized to help secure vial 18. This shim can be constructed of materials such as aluminum foil and should be placed between vial 18 and the surface that vial 18 contacts along side members 26 and 28. In the preferred embodiment, aluminum foil is used as the material for the shim as it is constructed from a material that is similar to what the insert is constructed of. Furthermore, aluminum is compatible with a UV light source used to cure the adhesive as described below.

After vial 18 is placed in vial insert 11 (a) it must be made level with respect to housing 12. This is accomplished by adjusting vial 18 such that bubble 30 is exactly between lines 32. The leveling of vial 18 is complete and the vial 18 must now be secured to vial insert 11(a) permanently.

The securing step is accomplished by placing an adhesive known in the art (not shown) on the ends of vial 18 whereby they come in contact with openings 37 or 39 along side portions 26 and 28. Preferably, the adhesive is an ultra violate cure adhesive (not shown) that is compatible with the materials it will come in contact with and which requires the added step of utilizing an ultra violate light source (not shown) to cure the adhesive. This process is repeated until all of the desired vials are placed within the vial insert 11(a) and properly calibrated to true level. This method can be repeated for any number of vial level inserts utilized with practicing the present invention, such as with vial insert 11 (b) or 11(c).

If the user wishes to use the vial insert 11(a) as a stand-alone level, he or she may do so. However, in this embodiment, lenses 40 and 42 would not be attached to the vial insert 11(a).

If the user wishes to use the vial inserts 11(a) or 11(c) asor part of spirit level 10, he or she may insert a vial insert 11(a) and/or (c) into apertures 48 and/or 52. Apertures 48 and 52 define precision machined cavities 66 that are shaped and sized to securely receive vial insert 11(a) or 11(c). As illustrated in FIG. 10, an O-ring or other suitable sealing means 38 is placed along the peripheral edge of either back or front portions 34 and 35 and one of the lens 40 or 42 secured to the side of casing 15 adjacent o-ring 38. The casing 15 is then inserted into aperture 48 such that the lens 40 is made flush with the body 12 of spirit level 10 and the end portions 33 of first and second vials 16 and 18 are facing towards top and bottom sides 54 and 56 of spirit level 10.

For vial insert 11(c), vials 216 and 218 may be diagonally aligned with top and bottom sides 54 and 56, respectively, at a 45 degree angle, or alternatively, one could simply place vial insert 11(c) with vials 216 and 218 oriented in the same position as vials 16 and 18 at a 45 degree angle within body 12. The assembly of vial insert 11(a) is completed when the other O-ring 38 is placed along the peripheral edge of casing 15 and the other lens 40 or 42 is secured to casing 15 by screws 41 or other securing means so that the vial insert 11(a) is fully attached to spirit level 10 through aperture 48. In this arrangement, O-rings 38 rest against second shoulders 70, while lens 40, 42 contact first shoulders 68

Referring to FIG. 11, the assembly of vial insert 11(b) into aperture 50 is performed substantially in the same manner as vial insert 11(a), except that insert 11(b) is oriented such that the end portions 33 of first and second vials 16 and 18 face toward opposing sides 58 and 60 of spirit level 10. The casing 115 is then inserted inside aperture 50 and lens 140 or 142 secured to the casing 115 as discussed above. Again, in this arrangement, O-rings 138 contact second shoulders 70, while lens 140 or 142 rest against first shoulders 168.

The present invention contemplates that apertures 48 and 52 could be adapted to receive vial insert 11(b) and aperture 50 adapted to receive inserts 11(a) or 11(c), or all three apertures 48, 50 and 52 could be adapted to receive just one type of vial insert or any arrangement of vial inserts 11(a), (b), or (c).

Preferably, body 12 is made from a durable wood, plastic, aluminum, or fiberglass; however, it is within the spirit and scope of the present invention that body 12 could also be made from a suitable metal, such as stainless steel or the like. Further, it is preferable that lens 40, 42 and 140, 142 be made from a glass or a transparent plastic material, such as plexiglass, which provides suitable protection to first and second vials 16, 18, 116, 118, and 216, 218. Similarly, first and second vials 16, 18, 116, 118 and 216, 218 can be made of a durable glass or a semi-transparent plastic material. Casings 15 and 115 are preferably made from a precision machined metal (e.g., brass, aluminum, anodized metals, plastics or phenolic materials) that is configured to provide a true level plane.

Preferably, first and second vials 16, 18, and 216, 218 are 8mm×30 mm bent tubular vials, while first and second vials 116 and 118 are 8 mm×2⅜ inches bent tubular vial.

An example of preferred dimensions for spirit level 10 might be a height of 2.4375 inches and a depth of 1.0625 inches. Also preferably, apertures 48 and 52 might have a height of 1.502 inches and a length of 1.752 inches, while aperture 50 may have a height of 1.502 inches and a length of 2.752 inches. First shoulders 66 and 166 and second shoulders 68 and 168 have the same heights even though the lengths may vary between embodiments of vial inserts (a), (b), and (c). For example, first shoulders 66 and 166 have a height of 0.5 inches, while second shoulders 68 and 168 have a height of 0.058 inches. However, the present invention contemplates that spirit level 10 may have other alternative dimensions. Furthermore, in a preferred embodiment the user may attach protective metal plates along the corners of the spirit level 10.

An example of preferred dimensions of the lens 40 and 42 would be a height of 1.470 inches and a length of 1.730 inches. Casing 15 may preferably have a height of 1.240 inches and a length of 1.50 inches, while the alternate embodiment, casing 115, may have a height of 1.240 inches and a length of 2.50 inches. Finally, O-rings 38 and 138 are configured to securely engage the peripheral edge of respective casings 15, 115 as shown in FIGS. 10 and 11.

It should be understood from the foregoing that, while particular embodiments of the invention have been illustrated and described, various modifications can be made thereto without departing from the spirit and scope of the invention. Therefore, it is not intended that the invention be limited by the specification; instead, the scope of the present invention is intended to be limited only by the appended claims.

I Claim:

1. A spirit level comprising:
a frame defining at least one aperture therethrough;
a pre-calibrated vial insert disposed in said at least one aperture including a housing further defining a chamber; and
at least one vial being disposed inside said chamber containing a liquid having a bubble therein, and attached to said housing such that said pre-calibrated vial insert is calibrated to show true level prior to insertion into said at least one aperture of said frame; said at least one vial including a marking for indicating true level.

2. The spirit level according to claim 1 wherein said frame is collectively defined by top and bottom portions, back and front portions, and opposing side portions, all of which define said at least one aperture therethrough.

3. The spirit level according to claim 1 further comprising a pair of sealing members disposed within said at least one aperture.

4. The spirit level according to claim 1 wherein said housing is collectively defined by top and bottom portions, back and front portions, and opposing side portions.

5. The spirit level according to claim 4 further comprising a pair of lenses attached to said pre-calibrated vial insert on said front and back portions of said housing.

6. The spirit level according to claim 5 wherein said pair of lenses are constructed of a polymer.

7. The spirit level according to claim 2 wherein said pre-calibrated vial insert is oriented so that said at least one vial is perpendicular to said top and bottom portions of said frame.

8. The spirit level according to claim 2 wherein said pre-calibrated vial insert is oriented so that said at least one vial is parallel to said top and bottom portions of said frame.

9. The spirit level according to claim 2 wherein said pre-calibrated vial insert is oriented so that said at least one vial is at a 45 degree angle to said top and bottom portions of said frame.

10. The Spirit level according to claim 9, further comprising a pre-calibrated vial insert is oriented so that said at least one vial is parallel to said top and bottom portions of said frame.

11. The spirit level according to claim 1 wherein said at least one vial is curved when placed in said chamber.

12. The spirit level according to claim 3 wherein said pre-calibrated vial insert is disposed against said pair of sealing members.

13. The spirit level according to claim 1 wherein said pre-calibrated vial insert includes a plurality of said vials disposed inside said chamber.

14. The spirit level according to claim 1 wherein said frame includes two or more pre-calibrated vial inserts which each have orientations that are perpendicular to one another.

15. A spirit level comprising:
a frame collectively defined by top and bottom portions, back and front portions, and opposing side portions, said frame further defining at least one aperture therethrough; and
a pre-calibrated vial insert disposed inside said at least one aperture;
said pre-calibrated vial insert including a housing, said housing defining a chamber with at least one vial containing a liquid having a bubble therein, said at least one vial being disposed inside said chamber and attached to said housing such that said pre-calibrated vial insert is calibrated to show true level prior to insertion into said at least one aperture of said frame, said at least one vial including a marking for indicating true level.

16. In combination, an easily removable pre-calibrated vial insert and a frame comprising:
the frame collectively defined by top and bottom portions, back and front portions, and opposing side portions, said frame further defining at least one aperture therethrough, wherein said at least one aperture is designed for receiving the pre-calibrated vial insert; and
the pre-calibrated vial insert being disposed said at least one aperture for receiving the pre-calibrated vial insert, the pre-calibrated vial insert including a housing, said housing further defining a chamber;
at least one vial containing a liquid having a bubble therein, said at least one vial being disposed inside said chamber and attached to said housing such that the pre-calibrated vial insert is calibrated to show true level prior to insertion into said one aperture for receiving the pre-calibrated vial insert, said at least one vial including a marking for indicating true level.

17. The combination according to claim 16 wherein said housing is collectively defined by top and bottom portions, back and front portions, and opposing side portions.

18. A pre-calibrated vial insert comprising;
a housing defining a chamber;
at least one vial containing a liquid, said at least one vial being disposed inside said chamber and attached to said housing;
said at least one vial each containing a bubble in said liquid and a marking on said vial for indicating true level when said bubble is located between said markings;
wherein said vial insert is calibrated such that said bubble is located between said markings when said vial insert is placed on a true level surface.
